(19) United States
(12) Patent Application Publication
(10) Pub. No.: US 2020/0396579 A1
(43) Pub. Date: Dec. 17, 2020

(54) Bluetooth/WLAN Dual Mode Low Power and High Speed Communications Protocol and Interface

(71) Applicant: Silicon Laboratories Inc., Austin, TX (US)

(72) Inventor: Subba Reddy KALLAM, Sunnyvale, CA (US)

(73) Assignee: Redpine Signals, Inc., San Jose, CA (US)

(21) Appl. No.: 16/442,748

(22) Filed: Jun. 17, 2019

(51) Int. Cl. H04W 4/80; H04W 84/12; H04W 88/06; H04W 48/16; H04L 29/06; H04W 76/11

(52) U.S. Cl. CPC H04W 4/80; H04W 84/12; H04W 76/11; H04W 48/16; H04L 63/20; H04W 88/06

(57) ABSTRACT

A low power device has a Bluetooth connection and a WLAN interface that can be enabled for high speed communication. The low power device is coupled to an application program running on a remote computer such as a tablet over Bluetooth. When a large amount of data is requested, the high speed WLAN interface is enabled as an Access Point (AP) and data transmitted or received over the low power device AP WLAN interface until the block of data is transferred, after which the WLAN connection is torn down, and the WLAN interface disabled. In this manner, the power consumption during high speed data transfers is minimized.

### FIELD OF THE INVENTION

The present invention relates to a communications interface providing low power and ease of connectivity with burst high speed performance for transfer of large blocks of data when required. In particular, the invention relates to using a Bluetooth connection to a Bluetooth device as a control interface to establish and tear down a WLAN access point connection for use by the Bluetooth device.

### BACKGROUND OF THE INVENTION

In the Bluetooth protocol, connections are easily and quickly made via the Bluetooth® (www.bluetooth.org) pairing protocol, where the pairing may automatically occur between two devices, one a master and one a slave according to the protocol. The Bluetooth transfer rate is typically limited to less than 3 Mbps, and a low power variant of the Bluetooth protocol known as Bluetooth Low Energy (BLE) provides very low power consumption. Bluetooth is accordingly desirable for its ease of connection and low power consumption, and is the protocol of choice for small battery powered devices, such as medical devices worn by a patient, including EKG monitors, EEG monitors, glucose monitors, and other monitors engaged in measurement of physiological data. A problem arises in that some of these monitors may record long series of data measurements generating large blocks of data for subsequent download, and the 3 MBPS data rate limit of Bluetooth may require a long download time, during which interval, other support functions also require power that could otherwise be disabled or powered down.

In the Wireless Local Area Network (WLAN) protocols of the IEEE (www.ieee.org) series of standards described by 802.11, the infrastructure mode of the protocol is commonly used by participating devices, where a device which wishes to associate to the WLAN network does so as a station (STA) associating to an access point (AP) with other stations, and the STA makes an association request to the AP which is broadcasting a Service Set Identifier (SSID), and the association is completed with the assertion of an authentication KEY, of which many KEY_TYPEs are supported, including the series described in the Wireless Encryption Protocol (WEP), which has since been replaced by the series described in the Wi-Fi Protected Access (WPA), Wi-Fi Protected Access 2 (WPA2), and Wi-Fi Protected Access 3 (WPA3) series of standards. For each of these authentication and encryption protocols, the associating station must know which KEY and KEY_TYPE to use to associate with a particular AP. WLAN protocols, such as those under 802.11, including 802.11a, 802.11g, 802.11n, and 802.11ac, each provide a variety of data modulations and associated communication speeds, including data transfer speeds of 600 MBPS (for 802.11n and 40 Mhz channels), or higher (such as 802.11ac). The disadvantage of using WLAN for miniature battery powered wireless communication is that the STA configuration is much more complex and interactive than Bluetooth, and the standby power consumption during WLAN communications is much higher than the power consumption of Bluetooth. Additionally, where there are other access points in operation, an associating STA must know a-priori which SSID it is to associate with, and it must know the KEY and KEY_TYPE, which are typically not universally known to the STA prior to association to the particular AP.

It is desired to provide an improved data communications apparatus and method providing low power communications as well as high speed communications.

### OBJECTS OF THE INVENTION

A first object of the invention is a communication system for a first Bluetooth low power device paired to a second Bluetooth device, the first Bluetooth device receiving or making a request for high speed data, the first Bluetooth device thereafter responding to the request by powering up and enabling a WLAN Access Point having an SSID, KEY_TYPE, and KEY, the first Bluetooth device transmitting the SSID, KEY, and KEY_TYPE to the second Bluetooth device, the second Bluetooth device thereafter enabling a WLAN interface and associating to the first station WLAN SSID using the KEY and KEY_TYPE, at least one of the first station or second station thereafter transmitting a block of high speed data to the other station using the WLAN interface, and at the end of the high speed data transmission, the first Bluetooth station or second Bluetooth station requesting the teardown of the WLAN STA connection, the request sent over either the Bluetooth interface or the high speed interface, the second Bluetooth station thereafter tearing down and powering down the WLAN AP until a future request is made.

A second object of the invention is a protocol for a low power first device, the low power first device being paired to a second device such as a tablet over a low power protocol such as Bluetooth, the second device or first device requesting a high speed connection over the low power protocol to the first device, the first device creating a WLAN AP with an SSID, KEY, and KEY_TYPE, the first device transmitting to the second device over the low power connection the WLAN credentials including the SSID, KEY, and KEY_TYPE, the first device transmitting or receiving a block of high speed data, the first device thereafter receiving an acknowledgement of receipt of the block of high speed data, the first device thereafter powering down the WLAN AP until a subsequent request for high speed connection.

A third object of the invention is a protocol for a high performance second device paired to a first low power device over a Bluetooth connection, the second device receiving a WLAN AP SSID, KEY, and KEY_TYPE over the Bluetooth connection, the second device thereafter making a WLAN association request using the SSID, KEY, and KEY_TYPE to the first device, the second device thereafter transmitting or receiving a block of high speed data, the second device thereafter tearing down the WLAN connection.

### SUMMARY OF THE INVENTION

A Bluetooth connection is established between a first device such as a low power portable device having a low power interface such as Bluetooth, and a high speed interface, such as a configurable WLAN interface capable of Access Point (AP) infrastructure mode, and a second device such as a tablet computer which has a corresponding low power interface such as Bluetooth, and also a corresponding high speed interface such as WLAN configurable to be placed into a station (STA) infrastructure mode. The first device or second device indicates that it wishes to transmit high speed data. In one example of the invention, when the first device or second device receives or issues a high speed data request, the first device creates a WLAN access point (AP) with an SSID, KEY, and KEY_TYPE, and transmits the SSID, KEY, and KEY_TYPE over the Bluetooth connection to the second device. The second device, upon receipt of the SSID, KEY, and KEY_TYPE, makes an association request over WLAN to the SSID using the KEY and KEY_TYPE. Once the WLAN connection is established, the high speed data of the request is transmitted as a block of data over a short interval of time, thereby minimizing power consumption, and the WLAN connection is torn down, the first device tearing down and removing power to the WLAN AP interface, and the second device disassociating from the SSID until a future request for high speed data.

### BRIEF DESCRIPTION OF THE DRAWINGS

FIG. 1 is a block diagram of a prior art Bluetooth link used by a first device such as a medical device and a second device such as a tablet.

FIG. 2 is block diagram for a prior art system similar to FIG. 1 using a Wireless LAN infrastructure.

FIG. 3 is a block diagram of the present invention.

FIG. 4 is a flowchart for the protocol of the present invention on a second device such as a tablet having a block of data to transmit or receive.

FIG. 5 is a flowchart for the protocol of the present invention on a first device such as a medical device having a block of data to transmit or receive.

### DETAILED DESCRIPTION OF THE INVENTION

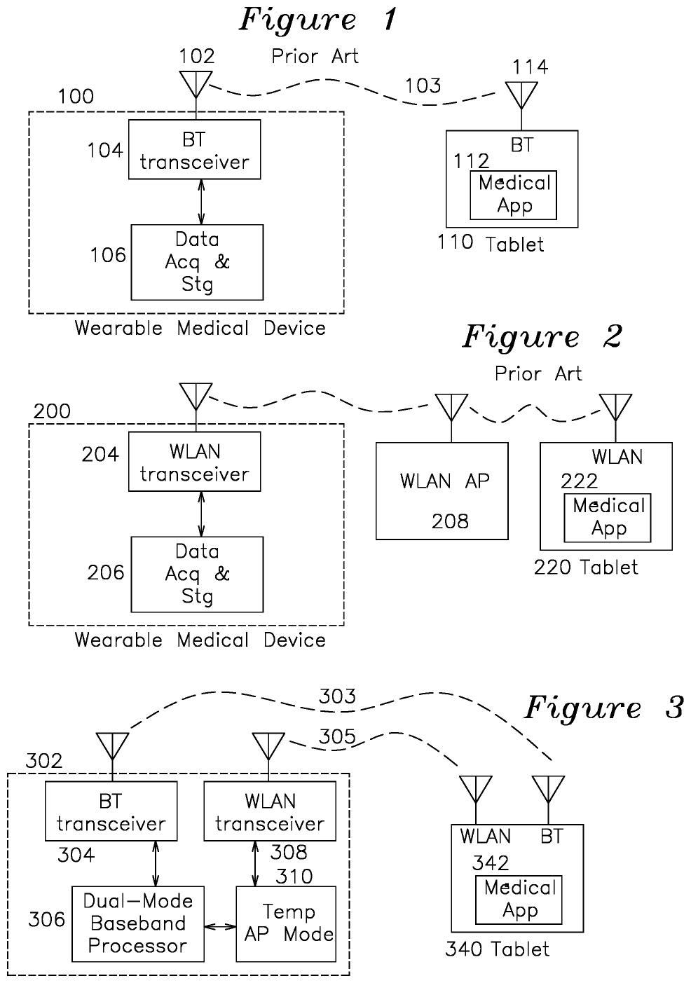

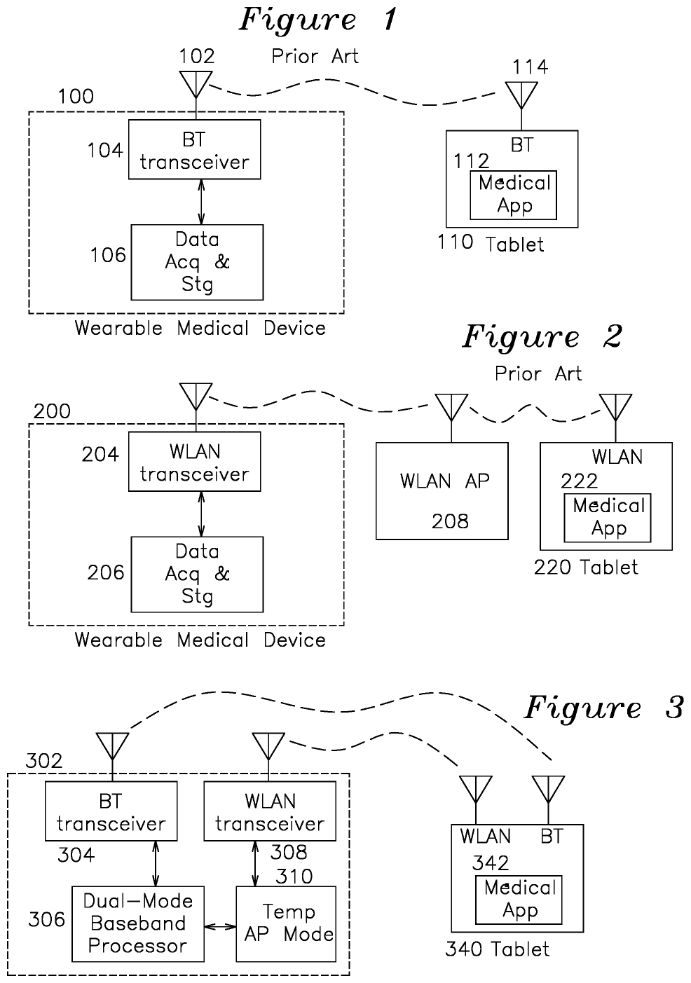

FIG. 1 shows an example prior art Bluetooth communication system, where a wearable medical device 100 is paired with a tablet 110 using the Bluetooth protocol. The example wearable medical device 100 has data in storage 106 to transmit (or alternatively to receive into storage 106), using the Bluetooth link 103 which includes transceiver 104, Bluetooth antenna 102, tablet antenna 114 and medical application 112. The system of FIG. 1 provides ease of connectivity through the Bluetooth pairing protocol but data transfers between 100 and 110 are limited in speed by the Bluetooth maximum data speed of 3 Mbps. The long duration of Bluetooth transactions with large amounts of data results in an undesirably increased battery drain, greatly reducing the remaining charge in the battery for other operations which may follow.

FIG. 2 shows an example prior art WLAN communication system, where a wearable medical device 200 with data storage 206 for data to transmit or be received passes through WLAN transceiver 204. Unlike Bluetooth, the WLAN infrastructure of FIG. 2 requires both the device 200 and tablet 220 be associated (connected according to IEEE 802.11 protocol) to access point 208, using the Service Set IDentifier (SSID) broadcast by AP 208, and using the particular association protocol (KEY_TYPE) and encryption key (KEY). In addition to the configuration complexity of both devices 200 and 220 associating to the AP 208, the steady state power consumption of a device operative using the WLAN protocol is much higher than the power consumption of a device operative using the Bluetooth protocol.

FIG. 3 shows an example of the present invention, where the example wearable medical device 302 includes a dual mode baseband processor 306 which is coupled to a Bluetooth transceiver 304 for Bluetooth communications, and also has an interface to a separately powered WLAN interface with a mode operative as an access point 310, which is coupled to a WLAN transceiver 308 and WLAN antenna. The tablet 340 has a Bluetooth and WLAN interface, and is operative with an application 342 which transmits or receives a block of data, but is primarily operative using low power Bluetooth connection 303, such as the Bluetooth Low Energy (BLE) protocol of Bluetooth to the device 302. In an example of operation of the invention, the low power device 302 has a WLAN Access Point (AP) mode 310 which is controllable and powered up or down by a baseband processor 306 which supports both the Bluetooth protocol as well as the WLAN protocols such as by separate interfaces. In one example of the invention, the baseband processor 306 is dual function and supports Bluetooth and WLAN protocols on separate interfaces, and provides the ability for the WLAN AP to be powered down separately from the Bluetooth interface. In operation, the Bluetooth mode of operation is primarily used with AP 310 powered off, and when a request for a large block of data is made by device 302 or by tablet 340, a series of operations is initiated to transmit the data as a single block or contiguous blocks until completed as follows:

1) a request is made for a block of data which is either to be received by, or initiated by, low power device 302.

2) the low power device 302 enables the AP mode 310 as a WLAN access point and initializes the AP with an SSID, KEY, and KEY_MODE, transmitting those parameters to the tablet 340 using the Bluetooth link 303.

3) The tablet 340 receives the SSID, KEY, and KEY_MODE, and uses these parameters as a WLAN station to make an association request to the AP 302.

4) After association of the tablet 340 to the AP 302, the block of data is transmitted by the low power device 302 or tablet 340 from WLAN to WLAN via link 305.

5) Upon completion of the block of data transmission via WLAN, the tablet 340 disassociates from the AP 302, and the low power device 302 powers down AP mode 310, saving power but maintaining the respective Bluetooth interfaces on each end of link 303.

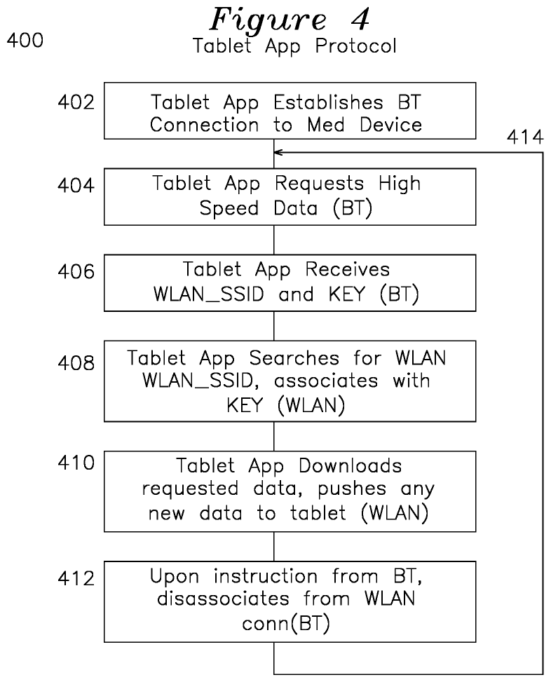

FIG. 4 shows a flowchart for the operation of the protocol 400 from the perspective of the tablet 340 of FIG. 3. The suffix indication (BT) or (WLAN) indicates the particular interface used for the request or acknowledgement. The Bluetooth interface and WLAN interface may be generalized to “low speed interface” and “high speed interface”, respectively, and the SSID, KEY_TYPE, and KEY generalized to high speed link connection parameters. The tablet first establishes Bluetooth communication with the low power device 302 in step 402. Upon a high speed data request 404 over Bluetooth, either transmitted by the low power device 302 or by the tablet 340 over the Bluetooth connection of step 402, in step 406, the tablet receives the WLAN connection parameters over the Bluetooth interface, including SSID, KEY, and KEY_TYPE. The Tablet application subsequently scans the available APs, and looks for a station with the matching SSID, thereafter making a WLAN association request using the KEY and KEY_TYPE, as shown in step 408. In step 410, the association between low power device 302 AP and tablet station 340 is complete, and the high speed data transfer is performed in the shortest time or preferably the least energy consuming WLAN modulation type as determined on a Joule per bit basis for selection in step 410. Typically, higher data rates consume slightly more power with a factor of 2 speed increase, thereby providing a lower Joule per bit metric as is preferred. Upon completion of the data transfer, the tablet disassociates from the WLAN connection and confirms this over the Bluetooth interface in step 412.

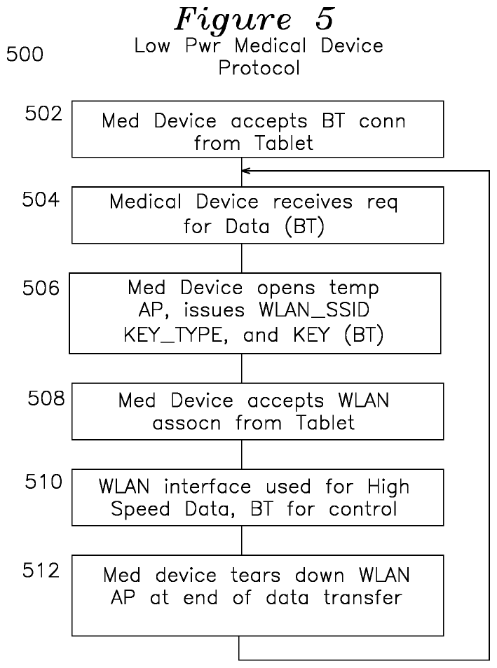

FIG. 5 shows an example of the method of the invention operative on the low power medical device 302 of FIG. 3. The Bluetooth connection is established 502, and a request for high speed data is made or received 504, which initiates the WLAN interface of low power device 302, and enables the WLAN interface as a WLAN AP with connection parameters of an SSID, KEY, and KEY_TYPE in step 506. The SSID, KEY, and KEY_TYPE connection parameters are also transmitted over the Bluetooth interface to the tablet 340 in step 506. Upon receipt of a WLAN association request from the tablet 340, the low power device accepts the association request and associates the WLAN station 340 to the low power device 302 AP, thereby establishing WLAN connectivity autonomously. The high speed data is transmitted (or received) over the WLAN interface in step 510, after which the AP is powered down in step 512 until a subsequent request for data in step 504, and returns to step 504 awaiting the next request for a block of high speed data.

The use of Bluetooth for low power communications and WLAN for episodic high speed communications is shown for understanding the invention only. Alternative high speed interfaces include Zigbee or any high speed wireless interface requiring configuration parameters which may be passed across a low power interface for use by the high speed interface on a temporary basis for transmission of contiguous blocks of data at a higher speed and lower power consumption per bit than provided by the low power interface.

The present examples are provided for illustrative purposes only, and are not intended to limit the invention to only the embodiments shown.

We claim:

1) A low power high speed communication device having a Bluetooth mode and a WLAN AP mode, the low power device comprising:
a baseband processor operative to communicate to an external device using a Bluetooth communication protocol;
a Bluetooth interface and a Wireless Local Area Network (WLAN) interface coupled to the dual mode baseband processor, the WLAN interface either powered down or operative in an Access Point (AP) mode, the AP having connection parameters comprising at least one of: an SSID, a KEY and a KEY_MODE;
the dual mode baseband processor, upon receipt of a request for high speed data or issuing a request for high speed data, enabling power to the WLAN interface operative in the AP mode and transmitting the connection parameters to a requesting station using the Bluetooth interface;
the high speed data transmitted over the WLAN AP until completion completion of the high speed data transmission, the baseband processor thereafter powering down the WLAN AP.

2) The low power high speed communication device of claim 1 where the baseband processor has a Bluetooth mode and a WLAN mode.

3) The low power high speed communication device of claim 2 where the WLAN AP is operative in at least one of the IEEE protocols 802.11b, 802.11g, 802.11n, or 802.11ac.

4) The low power high speed communication device of claim 1 where the Bluetooth interface is operative using the Bluetooth Low Energy (BLE) protocol.

5) The low power high speed communication device of claim 1 where the high speed data transmitted over the WLAN AP comprises one or more contiguous packets, the WLAN AP powered down thereafter.

6) A communication device having a Bluetooth interface and also an unassociated WLAN interface, the communication device operative to communicate with a remote device over the Bluetooth interface, the communication device, upon notification of a request for high speed data accompanied by WLAN connection parameters on the Bluetooth interface, using the WLAN connection parameters to associate with a matching WLAN, thereafter receiving high speed data from the WLAN interface, thereafter removing the association with the WLAN interface.

7) The communication device of claim 6 where the WLAN interface is a client mode operative in at least one of the IEEE wireless protocols 802.11b, 802.11g, 802.11n, or 802.11ac.

8) The communication device of claim 6 where the Bluetooth interface is at least partially compliant with Bluetooth Low Energy (BLE) protocol.

9) A communication system comprising:
a low power device having a Bluetooth interface and a WLAN interface operative to receive association requests and perform communications as an Access Point (AP) compliant with an IEEE 802.11 standard;
an application device having a screen for presentation of results, the application device also having a Bluetooth Interface and a WLAN interface;
the low power device, upon receipt of a request for high speed data, operative to transmit Access Point connection parameters to the application device using the Bluetooth interface, the low power device also enabling power to the AP and configuring the AP with the connection parameters;
the application device operative to receive the Access Point connection parameters, associate with the Access Point using the connection parameters, transmit high speed data to the Access Point or receive high speed data from the Access point, and disassociate from the Access point after transmission of the high speed data;
the low power device operative to disable its AP after transmitting or receiving high speed data from the application device.

10) The communication system of claim 9 where the Bluetooth protocol is BLE.

11) The communication system of claim 9 where the WLAN protocol is at least one of: 802.11b, 802.11g, 802.11n, or 802.11ac.

12) The communication system of claim 9 where the Access Point connection parameters comprise at least one of: a Service Set Identifier (SSID), key, or a key type.

13) The communication system of claim 12 where the key type is at least one of: WEP, WPA, WPA2, or WPA3.

14) A process for communication between a low power device and a master, the low power device having a Bluetooth interface, a Wireless Local Area Network (WLAN) Access Point (AP) controller, and a data store, the master having a Bluetooth interface and a WLAN interface, the process comprising:
the low power device making or receiving a request for a block of data in the data store;
the low power device enabling the AP controller and initializing the AP controller with AP connection parameters, including at least one of: an SSID, KEY, and KEY_MODE;
the low power device transmitting the AP connection parameter values to the master using the Bluetooth interface;
the master receiving the connection parameters, and making an association request to the AP using the connection parameters;
the master, after association with the low power device, transmitting or receiving a block of data to or from the low power device;
upon completion of the block of data transmission or reception, the master disassociating from the AP, and the low power device powering down the WLAN interface and maintaining the Bluetooth interface.

15) The process of claim 14 where the Bluetooth protocol is BLE.

16) The process claim 14 where the WLAN protocol is at least one of: 802.11b, 802.11g, 802.11n, or 802.11ac.

17) A method for communication between a low power device and a tablet device, the low power device and tablet having a shared wireless Bluetooth connection, the method comprising:
the low power device, upon a request for a block of data from the tablet device or upon a transmission request by the low power device, powering up and initializing a Wireless Local Area Network (WLAN) Access Point (AP) with connection parameters including at least one of: a Service Set Identifier (SSID) SSID, KEY, and KEY_TYPE;
the tablet, upon receipt of the connection parameters from the tablet, using the connection parameters to associate the tablet WLAN interface to the low power device WLAN AP and transmitting or receiving the block of data over the WLAN interface to the low power device;
the low power device, upon completion of the transfer of the block of data, powering down the WLAN AP interface until next needed;
the tablet, upon completion of the transfer of the block of data, disassociating from the SSID.

18) The process of claim 17 where the Bluetooth protocol is BLE.

19) The process claim 17 where the WLAN protocol is at least one of the IEEE standards 802.11b, 802.11g, 802.11n, or 802.11ac.
